(19) United States
(12) Patent Application Publication
(10) Pub. No.: US 2013/0278620 A1
(43) Pub. Date: Oct. 24, 2013

(54) METHOD OF STORING VIDEOS AND PORTABLE DEVICE

(71) Applicants: En-Min Jow, Hsin-Chu (TW); Yung-Ching Hung, Hsin-Chu (TW)

(72) Inventors: En-Min Jow, Hsin-Chu (TW); Yung-Ching Hung, Hsin-Chu (TW)

(73) Assignee: APTOS TECHNOLOGY INC., Hsin-Chu (TW)

(21) Appl. No.: 13/561,094

(22) Filed: Jul. 30, 2012

Related U.S. Application Data
(60) Provisional application No. 61/635,876, filed on Apr. 20, 2012.

(51) Int. Cl. G09G 5/36

(52) U.S. Cl. 345/547

(57) ABSTRACT

The invention is directed to a method of storing videos for a portable device having a buffer memory space and a storage device The method comprises recording a plurality of video frames and storing the video frames into the buffer memory space of the portable device and detecting an event. According to the event, a portion of the video frames recorded from a first predetermined time before the event is detected until the event is detected is restored into the storage device as a plurality of pre-event video frames and, meanwhile, a plurality of post-event video frames is continuously recorded for a second predetermined time after the event is detected and the post-event video frames are stored into the storage device, wherein the storage device is coupled to the portable device.

### CROSS-REFERENCE TO RELATED APPLICATION

This application claims the priority benefits of U.S. provisional application Ser. No. 61/635,876, filed on Apr. 20, 2012. The entirety of the above-mentioned patent application is hereby incorporated by reference herein and made a part of this specification.

### BACKGROUND OF THE INVENTION

1. Field of Invention

The present invention relates to a method of storing data and a portable device. More particularly, the present invention relates to a method of storing videos and a portable device.

2. Description of Related Art

Non-volatile memory is one of the most adaptable memories for such battery-powered portable products due to its characteristics such as data non-volatility, low power consumption and small volume. Generally, a driving recorder records the video frames and stores the video frames into a non-volatile memory. Since the limited storage size of the non-volatile memory, the previously stored video frames usually covered by the newly stored video frames. With the increasing of the times for repeatedly deleting previously recorded video files and newly storing video files into the same non-volatile memory, the life-time of the non-volatile memory decreases.

Therefore, how to prolong the non-volatile memory of the driving recorder and also well reserve the important video files related to the accident scene becomes an important task in the technology development.

### SUMMARY OF THE INVENTION

Accordingly, the present invention provides a method of storing videos capable of prolonging the life-time of the non-volatile memory of the portable device.

Further, the present invention provides a portable device capable of decreasing execution times for repeatedly deleting recorded video files and newly adding video files into the same non-volatile memory.

To achieve these and other advantages and in accordance with the purpose of the invention, as embodied and broadly described herein, the invention provides a method of storing videos for a portable device having a buffer memory space and a storage device, the method comprising recording a plurality of video frames and storing the video frames into the buffer memory space of the portable device and detecting an event. According to the event, a portion of the video frames recorded from a first predetermined time before the event is detected until the event is detected is restored into the storage device as a plurality of pre-event video frames and, meanwhile, a plurality of post-event video frames is continuously recorded for a second predetermined time after the event is detected and the post-event video frames are stored into the storage device, wherein the storage device is coupled to the portable device.

According to one embodiment of the present invention, the first predetermined time is about ten seconds.

According to one embodiment of the present invention, the second predetermined time is about ten seconds.

According to one embodiment of the present invention, the buffer memory space includes a cache memory, a data memory, a first-in-first-out memory (FIFO memory) or a volatile memory.

According to one embodiment of the present invention, step of storing the post-event video frames into the storage device comprises storing the post-event video frames into the buffer memory space and restoring the post-event video frames into the storage device.

According to one embodiment of the present invention, the pre-event video frames and the post-event video frames stored in the storage device are regarded as an event-related video data, and the method further comprises transmitting a backup video file of the event-related video data to an external data platform.

According to one embodiment of the present invention, the external platform includes an internet server, a cloud server, a personal computer, a smart phone, a secure digital card (SD card), a Micro SD card, or a flash drive.

According to one embodiment of the present invention, the portable device equipped with a positioning system and positioning information provided by the positioning system is related to a scene recorded in the pre-event video frames and the post-event video frame and is regarded as file information of the pre-event video frames and the post-event video frame while the pre-event video frames and the post-event video frames are recorded.

According to one embodiment of the present invention, the positioning information includes global positioning system information or assisted global positioning system information.

According to one embodiment of the present invention, the portable device includes a mobile phone, a smart phone, a tablet, a notebook or a personal digital assistant.

The invention further provides a portable device. The portable device comprises a storage device, a buffer memory, an event sensor and a central processing unit. The storage device stores a computer readable and writable program. The event sensor detects an event to generate a triggering signal accordingly. The central processing unit, coupled to the event sensor, the buffer memory space and the storage device, executes a plurality of commands of the computer readable and writable program. The commands include recording a plurality of video frames and storing the video frames into the buffer memory space of the portable device and receiving the triggering signal. According to the triggering signal, a portion of the video frames recorded from a first predetermined time before the triggering signal is received until the triggering signal is received are stored into a storage device as a plurality of pre-event video frames and, meanwhile, a plurality of post-event video frames is continuously recorded for a second predetermined time after the triggering signal is received and the post-event video frames are stored into the storage device.

According to one embodiment of the present invention, the pre-event video frames and the post-event video frames stored in the storage device are regarded as an event-related video data, and the portable device further comprises a data transmission interface, transmitting a backup video file of the event-related video data to an external data platform.

According to one embodiment of the present invention, the external platform includes an internet server, a cloud server, a personal computer, a smart phone, a secure digital card (SD card), a Micro SD card, or a flash drive.

According to one embodiment of the present invention, the portable device further comprises a positioning system, providing positioning information related to a scene recorded in the pre-event video frames and the post-event video frame as file information of the pre-event video frames and the post-event video frame while the pre-event video frames and the post-event video frames are recorded.

According to one embodiment of the present invention, the positioning information includes global positioning system information or assisted global positioning system information.

According to one embodiment of the present invention, the portable device includes a mobile phone, a smart phone, a tablet, a notebook or a personal digital assistant.

According to one embodiment of the present invention, the portable device further comprises a fixing holder, holding the portable device and fixing onto a vehicle.

According to one embodiment of the present invention, the fixing holder further comprises a mount part, an embedded antenna, a holding part and a power supply. The mount part mounts on the vehicle. The embedded antenna is embedded within the mount part. The holding part holds the portable device. The power supply is configured on the holding part and supplies power to the portable device.

According to one embodiment of the present invention, the buffer memory space includes a cache memory, a data memory, a first-in-first-out memory (FIFO memory) or a volatile memory.

In the present invention, according to the event, the video frames recorded within a predetermined period time before and after the event occurs or is detected are written into the storage device of the portable device from the buffer memory space of the portable device. Since the storage device can reserve the data even the power supply to the portable device is cut off, the important video frames related to the accident scene can be well reserved. Further, only when the portable device is triggered by the event, the event-related video frames are written into the storage device, the times for repeatedly deleting recorded video files and newly adding video files into the same storage device can be decreased. Therefore, the life-time of the storage device can be effectively prolonged.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a method of storing video according to one embodiment of the present invention.

FIG. 1A is a flow chart showing the step of restoring the post-event video frames into the storage device according to one embodiment of the present invention.

FIG. 1B is a flow chart showing the step of restoring the post-event video frames into the storage device according to another embodiment of the present invention.

FIG. 2 is a schematic block diagram showing a portable device according to one embodiment of the present invention.

FIG. 2A is a schematic block diagram showing a buffer memory space applied within a device according to another embodiment of the present invention.

FIG. 3 is a schematic drawing showing possible hit directions in the car accident.

FIG. 4 is a schematic drawing of a vector system showing the response of each g-force of each axis.

FIG. 5 is a schematic drawing showing a fixing holder of the portable device according to one embodiment of the present invention.

### DESCRIPTION OF THE PREFERRED EMBODIMENTS

In the invention, all video frames are temporarily stored in the buffer memory space of a portable device. The portable device can be, for example, a mobile phone, a smart phone, a tablet, a notebook, a personal digital assistant or any portable device having video recording function. The buffer memory space can be, for example, a cache memory, a data memory, a first-in-first-out memory (FIFO memory), a volatile memory or the memory in which the data are disappeared after the power supply to the memory is cut off. Further, for instance, as for the size of each of the video frames of about 640×480, the memory can store the video with a recording time of about 20 seconds. Furthermore, the video frames are continuously and circularly stored in the buffer memory space. That is, it is possible that the newly recorded video frames will cover the stored old video frame.

When an event is detected, the mechanism of storing video according to the present invention is performed to well reserve the video frames temporally stored in the buffer memory space. The event can be, for example, a car accident or a violent hit. In the mechanism of storing video according to the present invention, the video frames recorded from about a first predetermined time before the event is detected until the event is detected are restored into a storage device. Further, the video frames are continuously recorded for about a second predetermined time after the event is detected and are also stored into the storage device. That is, even after the event occurs/is detected, the car accident scene or the violent hit scene are continuously recorded to be video frames for about the second predetermined time. It should be noticed that the storage device can be, for example, a non-volatile memory, a NAND flash memory, a secure digital card (SD card), Micro SD card, flash drive or a memory in which the data is still reserved even after the power supply to the memory is cut off.

More specifically, when the event is detected, the video frames recorded from the first predetermined time before the event is detected until the event is detected and the video frames recorded for the second predetermined time after the event is detected are all stored into the storage device. In other words, according to the event occurring time or the event detected time, the video frames recorded within a first time slot right before the event occurs or is detected and the video frames recorded within a second time slot right after the event occurs or is detected are all restored into the storage device. Therefore, even the power supply to the portable device is cut off, the video frames closely related to the events can be well reserved. In one embodiment, the video frames recorded for the second predetermined time even after the event is detected are stored into the buffer memory space and then are restored into the storage device. In another embodiment, the video frames recorded for the second predetermined time after the event is detected are real-time stored into the storage device of the portable device. It should be noticed that the first predetermined time can be equal to or different from the second predetermined time. Furthermore, the first predetermined time is about ten seconds, for example. Also, the second predetermined time is about ten seconds, for example.

Several embodiments are illustrated accompanied with the corresponding drawings in the following paragraphs for further detailing the present invention. In the embodiments, the video frames recorded within a first time slot (which is from the first predetermined time before the event is detected until the event is detected) right before the event occurs or the event is detected are named as the pre-event video frames for simplifying the description. Also, the video frames recorded within a second time slot (which is from the time the event is detected to the second predetermined time after the event is detected) right after the event occurs or the event is detected are named as the post-event video frames for simplifying the description.

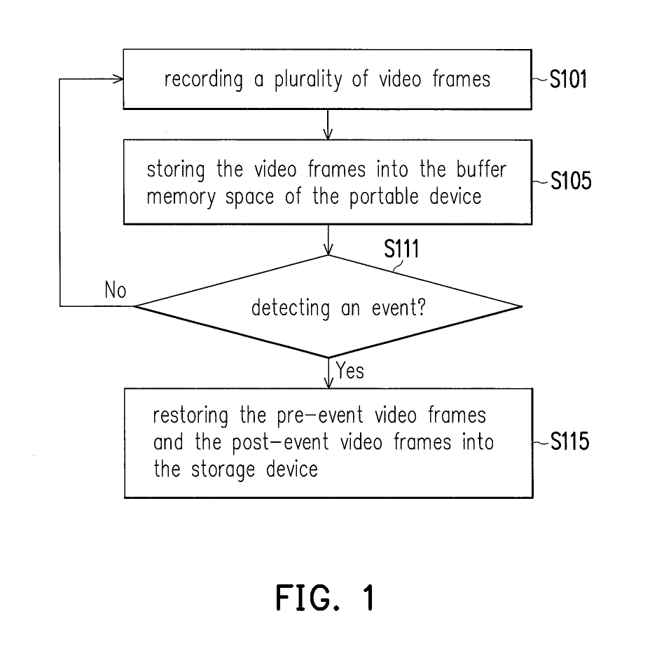

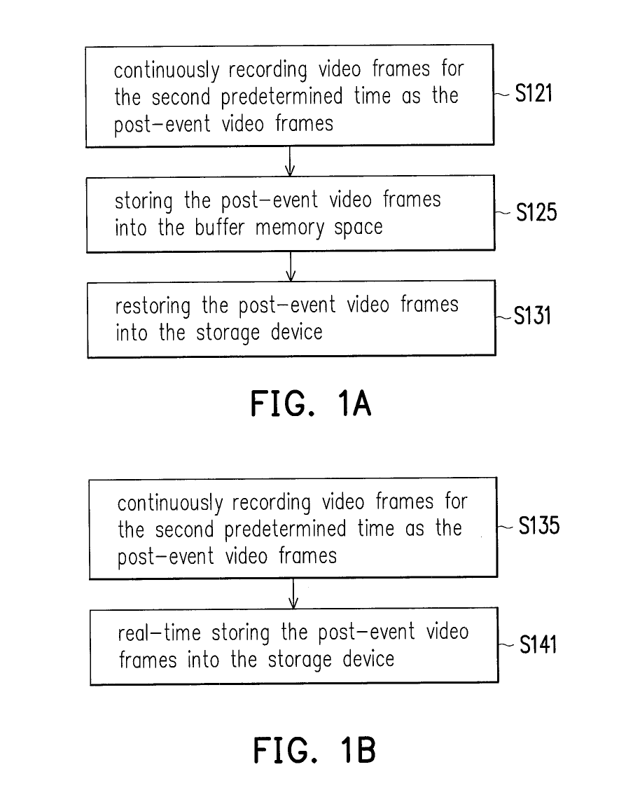

FIG. 1 is a flow chart illustrating a method of storing video according to one embodiment of the present invention. As shown in FIG. 1, in the present embodiment, a portable device is used for implementing the method according to the invention. The portable device comprises a buffer memory space and a storage device. Also, the portable device can be, for example, a mobile phone, a smart phone, a tablet, a notebook, a personal digital assistant or any portable device having the video recording function. The buffer memory space can be, for example, a cache memory, a data memory, a first-in-first-out memory (FIFO memory), a volatile memory or the memory in which the data are disappeared after the power supply to the memory is cut off. Moreover, the storage device can be, for example, a non-volatile memory, a NAND flash memory, a secure digital card (SD card), Micro SD card, flash drive or a memory in which the data is still reserved even after the power supply to the memory is cut off.

In the step S101, a plurality of video frames are recorded. Then, in the step S105, the video frames are stored into the buffer memory space of the portable device.

Thereafter, in the step S111, it is determined whether an event is detected. When the event is detected, the pre-event video frames stored in the buffer memory space and the post-event video frames are stored into the storage device (step S115). Otherwise, when no event is detected, the portable device keeps on recording video frames.

FIG. 1A is a flow chart showing the step of restoring the post-event video frames into the storage device according to one embodiment of the present invention. As shown in FIG. 1A, in the step S121, even after the event is detected, the portable device keeps on records video frames for the second predetermined time as the post-event video frames and, then, in the step S125, the post-event video frames are stored into the buffer memory space. Thereafter, the post-event video frames are restored into the storage device (step S131).

FIG. 1B is a flow chart showing the step of restoring the post-event video frames into the storage device according to another embodiment of the present invention. As shown in FIG. 1B, in the step S135, even after the event is detected, the portable device keeps on records video frames for the second predetermined time as the post-event video frames and, in the step S141, the post-event video frames are real-time stored into the storage device.

In one embodiment, the pre-event video frames and the post-event video frames stored in the storage device are regarded as an event-related video data. Further, after or at the time the event-related video data is stored, a backup video file of the event-related video data is transmitted to an external data platform. It should be noticed that the external platform can be, for example, an internet server, a cloud server, a personal computer, a smart phone, a secure digital card (SD card), a Micro SD card, or a flash drive.

In the other embodiment, the portable device can be further equipped with a positioning system. Therefore, the positioning information provided by the positioning system and related to a scene recorded in the pre-event video frames and the post-event video frame is regarded as the file information of the pre-event video frames and the post-event video frame while the pre-event video frames and the post-event video frames are recorded. That is, while the pre-event video frames and the post-event video frames are stored into the storage device, the positioning information of the pre-event video frame and the post-event video frames is stored as well. The positioning information includes a global positioning system (GPS) information, a assisted global positioning system (AGPS) information. In other words, for each of the stored video frames, not only the effective scene images are well stored but also the GPS/AGPS information (such as longitude and latitude coordinates, speed information, time information or height information) related to the scene can be stored.

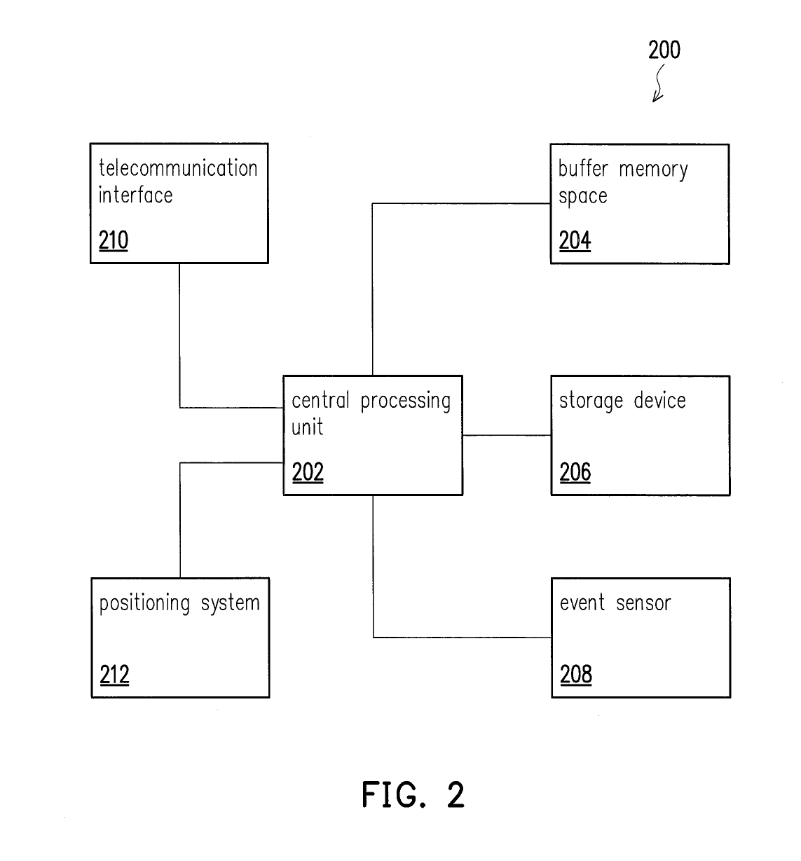

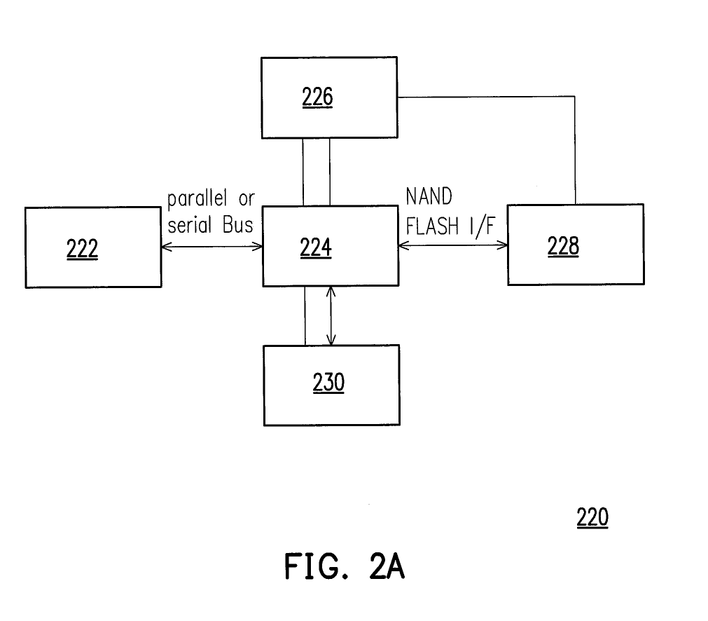

FIG. 2 is a schematic block diagram showing a portable device according to one embodiment of the present invention. As shown in FIG. 2, the portable device 200 of the present embodiment comprises a central processing unit 202, a buffer memory space 204, a storage device 206 and an event sensor 208. The event sensor 208 detects an event to generate a triggering signal accordingly. The storage device 206 stores a computer readable and writable program. The central processing unit 202, which is coupled to the event sensor 208, the buffer memory space 204 and the storage device 206, executes a plurality of commands of the computer readable and writable program to implement several steps of the method mentioned in the previous embodiment. The commands include recording a plurality of video frames (step S101) and storing the video frames into the buffer memory space 204 of the portable device 200 (step S105). Further, the commands include receiving the triggering signal sensed by the event sensor 208 (corresponding to the step S111) and, according to the triggering signal, restoring a portion of the video frames recorded from the first predetermined time before the triggering signal is received until the triggering signal is received into the storage device 206 and, meanwhile, continuously recording a plurality of post-event video frames for the second predetermined time after the triggering signal is received and storing the post-event video frames into the storage device (corresponding to the step S115). The details of the steps S101 through S115 are described in the previous embodiment and are not described herein.

FIG. 2A is a schematic block diagram showing a buffer memory space applied within a device according to another embodiment of the present invention. As shown in FIG. 2A, the buffer memory space of the present invention can be also applied into a storage system 220 composed of solid state drive (SSD) or non-volatile memory. The aforementioned device 220 comprises an external data source, a controller 224, a power supply system 226, a non-volatile memory 228 and a volatile memory 230. The external data source 222 can be a computer terminal or any device possessing active control power or operating system. The controller 224 can be any processing unit capable of programming or executing instructions or commands. The power supply system 226 provides the power for the whole storage system and, when the storage system departed from the external data source, the power supply still can provide the power for some time (such as from a few seconds to a few minutes). The non-volatile memory 228 can be, for example, the well-known NAND flash memory, the SD card, the micro SD card or the high capacity SD memory card (SDHC) in which the data does not disappear after the power is cut off. The volatile memory 230 can be, for example, the cache memory, the double data rate (DDR) memory, DRAM or SRAM in which the data disappears after the power is cut off.

The role of the buffer memory space (the volatile memory) of the present invention applied into a storage system 220 composed of solid state drive (SSD) or non-volatile memory includes:

1. while the external data source writes data into the non-volatile memory, the controller writes the whole data into the volatile memory in advance so that the damages of the non-volatile memory due to the repeated read-and-write operation done by the external data source onto the non-volatile memory can be greatly decreased; and

2. when the amount of data stored in the volatile memory reaches the storage space upper limit, the storage system departed from the external data source (at this time, the power supply system provides enough power to the storage system so that the data can be entirely written into the non-volatile memory) or the storage system and the external data source update the relative information in the non-volatile memory in response to the demands of the application, the data in the volatile memory is written into the non-volatile memory.

Moreover, the contribution of the buffer memory space (volatile memory) of the present invention includes:

1. before the data is ready, the counts of the unnecessary data writing operation and the unnecessary data updating operation which are done on the non-volatile memory can be decreased so that the lifetime of the non-volatile memory can be increased;

2. when the buffer memory space is applied with the wear leveling technology, the lifetime of the non-volatile memory can be increased.

It should be noticed that the event sensor can be, for example, an accelerometer built in the portable device. The accelerometer can operate a 3-axis vector operation. Furthermore, the event sensor, in another embodiment, can be, for example, a CMOS sensor, a G-sensor, a gyro sensor, a compass sensor, a smoke sensor, a temperature sensor, a moisture sensor or an image analyzer.

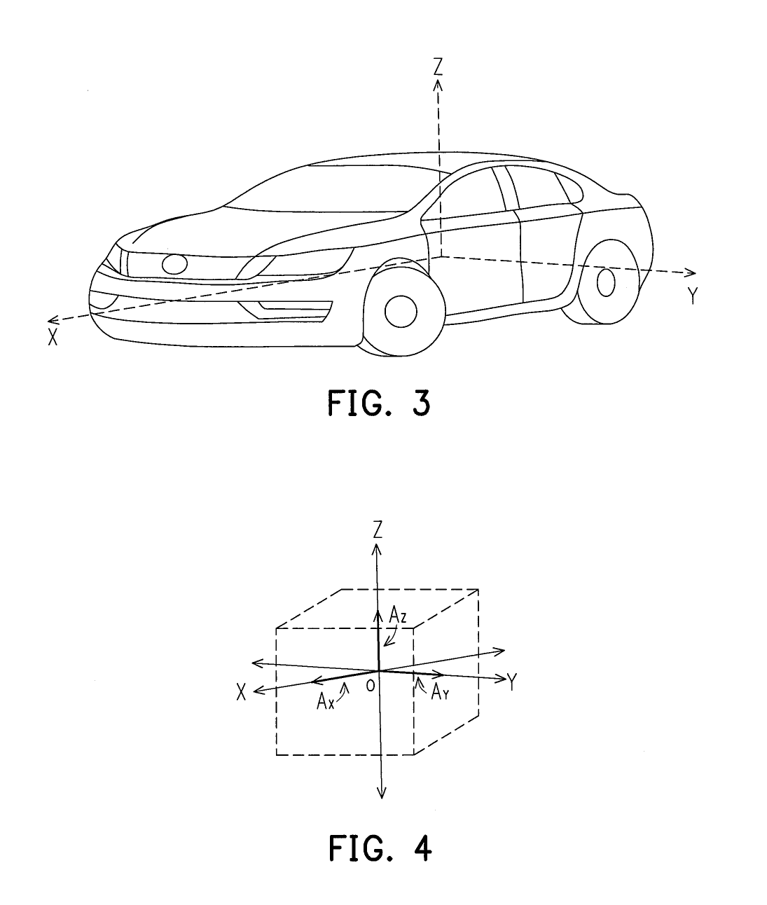

FIG. 3 is a schematic drawing showing possible hit directions in the car accident. As shown in the FIG. 3, the possible hit directions during the vehicle moves can be classified into three axes which are X-axis, Y-axis and Z-axis. The hit situation when the hit direction is along the X-axis is that the vehicle is hit from behind, the vehicle hits the front vehicle or the vehicle makes an emergency stop so that the g-force changes as the speed of the vehicle suddenly decreases from high to low in a short time. Accordingly, the impact strength produced by the hit or the g-force in X-axis is represented by Ax. The hit situation when the hit direction is along the Y-axis is that the vehicle is hit from the side of the vehicle. Therefore, the impact strength produced by the hit in Y-axis is represented by Ay. The hit situation when the hit direction is along the Z-axis is that the vehicle bumps on the rough road. Hence, the impact strength produced by the hit in Z-axis is represented by Az. In the vehicle accident analysis, the system decreases the weight of the z-axis factor to avoid the wrongfully triggering the event due to the minor bumping.

FIG. 4 is a schematic drawing of a vector system showing the response of each g-force of each axis. As shown in FIG. 4, labels Ax, Ay and Az are the impact strengths of three axes of the accelerometer built in the portable device respectively. When the impact from any direction exceeds the protective range circled by the dotted lines shown in FIG. 4, the portable device is triggered to write the video frames stored in the buffer memory space into the storage device of the portable device. For instance, when a 1.5-ton vehicle drives in the speed of about 30 KM/Hr, the impact strength is about 21.75 G, and the determination standard for the portable device to determine whether the hit occurs or the speed of the vehicle is suddenly decreased is about 10 G which is almost half of the aforementioned impact strength. Therefore, it makes sure that when the vehicle equipped with the portable device hits objects, is hit by other object or suddenly slows down, the portable device can be triggered to write the video frames from the buffer memory space into the storage device in the portable device.

Taking single X axis as an example, when the vehicle with the portable device hits objects, is hit by others or suddenly slows down, a positive g-force produces. Alternatively, when the vehicle with the portable device suddenly speeds up in a short time, a negative g-force produces. When determining the Ax, Ay and Az, the portable device only considers the absolute values of impact strengths Ax, Ay and Az according to the following equations:

A_{X+}=abs(Ax),A_{Y+}=abs(Ay) and A_{Z+}=abs(Az)

Then, A_{X+}, A_{Y+} and A_{Z+} are applied onto the corresponding axes. Hence, no matter the portable device is triggered by the vehicle hitting the front car, the vehicle being hit from behind, the vehicle making an emergency stop or the vehicle being hit from the side of the vehicle, the portable device is accurately triggered to write the video frames from the buffer memory space into the storage device in the portable device.

In the previous embodiment, the event detected by the event sensor includes the car accident or a violent hit. However, the present invention is not limited thereto. In another embodiment, the portable device is triggered to write the video frames stored in the buffer memory space into the storage device of the portable device by the triggering signal generated by the event sensor while the change of the environment is detected by the event sensor. The change of the environment includes, for example but not limited to, the change of temperature, the change of moisture, the change of smoke amount or the image change of the object in the video frames. In other words, once the event sensor of the portable device detects the change of the environment, the event sensor generates a triggering signal and, accordingly, the mechanism for storing the pre-event video frames and the port-event video frames into the storage device (step S115) according to the present invention mentioned above is performed.

As shown in FIG. 2, the portable device 200 further comprises a data transmission interface 210. When the portable device is triggered to write the event-related video data including the pre-event video frames and the post-event video frames into the storage device, the central processing unit 202 of the portable device 200 executes the commands to further transmit a backup video file of the event-related video data to an external data platform through the data transmission interface 210. It should be noticed that the external platform includes an internet server, a cloud server, a personal computer, a smart phone, a secure digital card (SD card), a Micro SD card, or a flash drive.

In one embodiment, when the portable device only supports General Packet Radio Service (GPRS) communication system, the portable device uses short message service (SMS) to transmit the positioning information to the external data platform. In another embodiment, when the portable device supports 3G/WCDMA/3.5G/HSDPA/4 G communication system or above, the portable device transmits the video frames and the positioning information to the external data platform. In this scenario, the external data platform performs the actions including connecting the rescue organization or backup the received video frames.

Also, as shown in FIG. 2, the portable device 200 further comprises a positioning system 212. When the central processing unit 202 of the portable device 200 executes the commands to record the video frames and store the video frames into the buffer memory space or into the storage device, the positioning information which is related to a scene recorded in the pre-event video frames and the post-event video frame and is provided by the positioning system is stored with the pre-event video frames and the post-event video frames as the file information of the pre-event video frames and the post-event video frame. The positioning information includes global positioning system information or assisted global positioning system information.

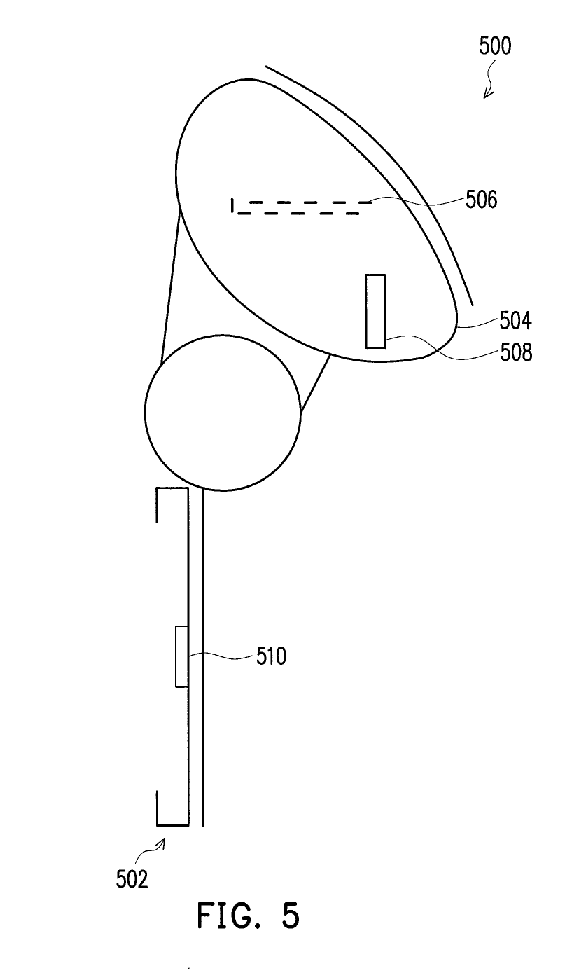

FIG. 5 is a schematic drawing showing a fixing holder of the portable device according to one embodiment of the present invention. As shown in FIG. 5, the fixing holder 500 can hold the portable device with a holding part 502 and fixes onto the vehicle through a mount part 504. The fixing holder 500 further comprises an embedded antenna 506, a memory card socket 508 and a power supply 510. The embedded antenna 506 is embedded within the mount part 504 and the power supply 510 is configured on the holding part 502 and supplies power to the portable device. Moreover, the memory card socket 508 for connecting the memory card to the portable device held by the holding part 205 so that the backup video file of the event-related video data can be immediately transmitted to the memory card which is regarded as an external data platform.

In the present invention, according to the event, the video frames recorded within a predetermined period time before and after the event occurs or is detected are written into the storage device of the portable device from the buffer memory space of the portable device. Since the storage device can reserve the data even the power supply to the portable device is cut off, the important video frames related to the accident scene can be well reserved. Further, only when the portable device is triggered by the event, the event-related video frames are written into the storage device, the times for repeatedly deleting recorded video files and newly adding video files into the same storage device can be decreased. Therefore, the life-time of the storage device can be effectively prolonged.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method of storing videos for a portable device having a buffer memory space and a storage device, the method comprising:
recording a plurality of video frames and storing the video frames into the buffer memory space of the portable device;
detecting an event; and
according to the event, restoring a portion of the video frames recorded from a first predetermined time before the event is detected until the event is detected into the storage device as a plurality of pre-event video frames and, meanwhile, continuously recording a plurality of post-event video frames for a second predetermined time after the event is detected and storing the post-event video frames into the storage device, wherein the storage device is coupled to the portable device.

2. The method of claim 1, wherein the first predetermined time is about ten seconds.

3. The method of claim 1, wherein the second predetermined time is about ten seconds.

4. The method of claim 1, wherein the buffer memory space includes a cache memory, a data memory, a first-in-first-out memory (FIFO memory) or a volatile memory.

5. The method of claim 1, wherein the step of storing the post-event video frames into the storage device comprises:
storing the post-event video frames into the buffer memory space; and
restoring the post-event video frames into the storage device.

6. The method of claim 1, wherein the pre-event video frames and the post-event video frames stored in the storage device are regarded as an event-related video data, and the method further comprises:
transmitting a backup video file of the event-related video data to an external data platform.

7. The method of claim 6, wherein the external platform includes an internet server, a cloud server, a personal computer, a smart phone, a secure digital card (SD card), a Micro SD card, or a flash drive.

8. The method of claim 1, wherein the portable device equipped with a positioning system and positioning information provided by the positioning system is related to a scene recorded in the pre-event video frames and the post-event video frame and is regarded as file information of the pre-event video frames and the post-event video frame while the pre-event video frames and the post-event video frames are recorded.

9. The method of claim 8, wherein the positioning information includes global positioning system information or assisted global positioning system information.

10. The method of claim 1, wherein the portable device includes a mobile phone, a smart phone, a tablet, a notebook or a personal digital assistant.

11. A portable device, comprising:
a storage device, storing a computer readable and writable program;
a buffer memory;
an event sensor, detecting an event to generate a triggering signal accordingly;
a central processing unit, coupled to the event sensor, the buffer memory space and the storage device, and executing a plurality of commands of the computer readable and writable program, and the commands include:
recording a plurality of video frames and storing the video frames into the buffer memory space of the portable device;
receiving the triggering signal; and
according to the triggering signal, restoring a portion of the video frames recorded from a first predetermined time before the triggering signal is received until the triggering signal is received into a storage device as a plurality of pre-event video frames and, meanwhile, continuously recording a plurality of post-event video frames for a second predetermined time after the triggering signal is received and storing the post-event video frames into the storage device.

12. The portable device of claim 11, wherein the pre-event video frames and the post-event video frames stored in the storage device are regarded as an event-related video data, and the portable device further comprises:
a data transmission interface, transmitting a backup video file of the event-related video data to an external data platform.

13. The portable device of claim 12, wherein the external platform includes an internet server, a cloud server, a personal computer, a smart phone, a secure digital card (SD card), a Micro SD card, or a flash drive.

14. The portable device of claim 11, further comprising:
a positioning system, providing positioning information related to a scene recorded in the pre-event video frames and the post-event video frame as file information of the pre-event video frames and the post-event video frame while the pre-event video frames and the post-event video frames are recorded.

15. The portable device of claim 11, wherein the positioning information includes global positioning system information or assisted global positioning system information.

16. The portable device of claim 11, wherein the portable device includes a mobile phone, a smart phone, a tablet, a notebook or a personal digital assistant.

17. The portable device of claim 11, further comprising:
a fixing holder, holding the portable device and fixing onto a vehicle.

18. The portable device of claim 17, wherein the fixing holder further comprises:
a mount part, mounting on the vehicle;
an embedded antenna, embedded within the mount part;
a holding part, holding the portable device; and
a power supply, configured on the holding part and supplying power to the portable device.

19. The portable device of claim 11, wherein the buffer memory space includes a cache memory, a data memory, a first-in-first-out memory (FIFO memory) or a volatile memory.
